(19) United States
(12) Patent Application Publication
(10) Pub. No.: US 2004/0085036 A1
(43) Pub. Date: May 6, 2004

(54) System and method for assuring safe security barrier operation

(75) Inventors: Wayne C. Hom, Rancho Santa Margarita, CA (US); Walter Parsadayan, Lake Forest, CA (US)

Correspondence Address: LEVIN INTELLECTUAL PROPERTY GROUP, 384 FORESET AVE, SUITE 13, LAGUNA BEACH, CA, 92651, US

(73) Assignee: Elite Access Systems, Inc.

(21) Appl. No.: 10/386,770

(22) Filed: Mar. 11, 2003

Related U.S. Application Data
(60) Provisional application No. 60/422,981, filed on Nov. 1, 2002.

(51) Int. Cl. H02P 1/00

(52) U.S. Cl. 318/460

(57) ABSTRACT

A system for preventing a security gate from making hard contact with an object in its path is disclosed. The apparatus detects the presence of an object by use of ultra sonic detectors that use ultra sonic transceivers. When an object is detected the gate operator makes the appropriate calculations to avoid hitting the object. The system operates continuously and can determine if the object is still in the protected area or has moved beyond the protected area.

The present application claims the benefit and priority of previously filed provisional application titled “A System and Method for Assuring Safe Security Barrier Operation”, serial No. 60/422,981 filed on Nov. 1, 2002.

### FIELD OF THE INVENTION

The present invention relates to a system for control and operation of a movable security barrier system and more particularly to a system and method for detecting objects within the area of barrier operation to assure safe barrier operation.

### BACKGROUND OF THE INVENTION

Security gate or barrier systems are in wide spread use by gated communities, apartment complexes, industrial installations or the like. One of the key features of such systems are movable barriers or gates controlled by gate controllers. The gate or barrier only opens to allow entry or exit from the secure area after appropriate authorization has been obtained and the barrier operator has been appropriately activated. Once activated the barrier will open or close. In some instances the barrier is of the swing or sliding gate or door in others it might be a gate or bar that is raised and lowered.

One of the dangers in the operation of the typical security barrier is that injury or damage might occur while one is going through the opening created by movement of the barrier. Often the gate or barrier has a contact sensor that upon inadvertent contact with an object in the path of the moving barrier stops or reverses movement of the barrier. However, even if this type of sensor is in use, damage and injury can result due to the fact that these types of sensors only actuate upon physical contact with an object.

Inductive loops installed in the roadway that passes through and adjacent to the barrier are another example of devices that are used to sense the presence of an object and thereby avoid damage or injury. However, inductive loops, since they are essentially magnetic based detectors are only useful in detecting motor vehicles or similar large metal objects. They cannot detect non-metal objects or metal objects with low metal mass. Additionally, inductive loops and the sensing circuits that operate with them are subject to malfunctions, due to false readings and ambient temperature changes. When this occurs they lose all usefulness and may make operation of the barrier even more dangerous.

Thus, what is needed is a system and method that can assure safe and efficient operation of a movable security barrier system by detecting and identifying objects in and moving through the operational area of a movable security barrier. Such a system must be economical to install and operate, not be subject to operational failures due to changes in ambient temperature or weather conditions.

### SUMMARY

It is an objective of the present invention to provide a system and method that can assure safe and efficient operation of a movable security barrier by detecting and identifying in and moving through an operational area of a the barrier. It is also and an objective of the present invention to provide a system that is economical to install on both existing and new security barrier installations and that is not subject to interference by ambient weather or temperature conditions.

The present invention achieves these and other objectives by providing a system for safe operation of a security barrier having: a. a barrier movable between an open and closed position to thereby control access to a security area; b. a barrier motor to provide power to move the barrier between the open and closed position; c. a gear mechanism engage able by the barrier motor and operatively connected to transfer power from the motor thereby move the gate between an open and closed position; d. a barrier controller operatively connected to the motor to control operation of the motor and thereby control opening and closing of the barrier; e. an ultrasonic sensor positioned to monitor areas at and adjacent to the barrier; and f. an analysis unit to sense objects sensed by the ultrasonic sensor within the areas at and adjacent to the barrier and signal the controller when it is safe to open or close the barrier.

In a further aspect of the present invention it has a plurality of ultrasonic sensors. These ultrasonic sensors are positioned in the areas at and adjacent to the barrier to thereby obtain an ultrasonic image of any object within these areas. The analysis unit uses image information obtained from the ultrasonic sensors to signal the barrier controller how to operate the barrier.

### BRIEF DESCRIPTION OF THE DRAWINGS

The invention will be better understood by an examination of the following description, together with the accompanying drawings, in which:

FIG. 1 is a schematic block type of diagram that depicts some of the major functional components the system of the present invention would have; and

FIG. 2 is a diagram of one placement of ultrasonic sensors with respect to the barrier.

FIG. 3 is a schematic diagram of an overview of an ultrasonic transmission device and its range of coverage; and

FIG. 4 is an over view of a security gate with three ultrasonic sensors.

### DETAILED DESCRIPTION OF THE PREFERRED EMBODIMENT

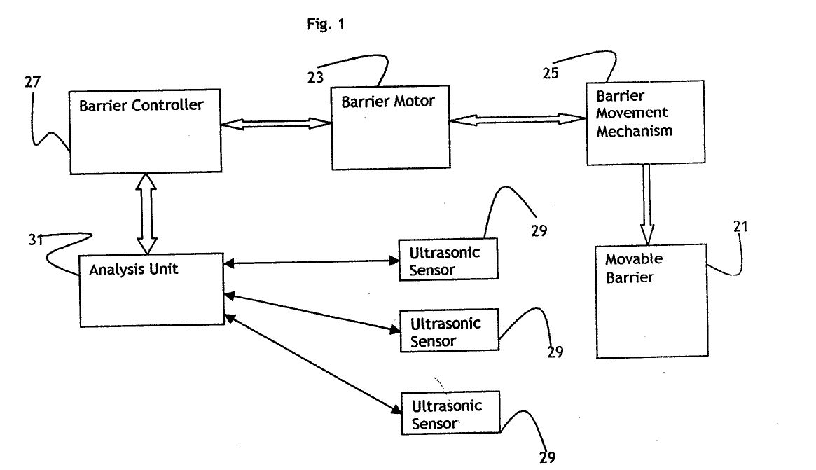

The present invention uses ultrasonic sensors to image the area in and around a security gate. The imaging information obtained is then analyzed and the function of the gate is controlled based on this information to avoid injury or damage to those using the security gate entrance. If the system determines that a vehicle or individual passing through the gate is still within the movement range of the gate it will accordingly stop or reverse operation before the gate strikes the individual. FIG. 1 is a schematic block diagram of the major functional components with which the system would operate. Among these functional include the movable barrier 21, typically a gate, barrier motor 23, barrier movement mechanism 25, typically a gear and/or belt drive system that transfer the kinetic energy from motor 23 to barrier 21 to cause it to move between the open and closed position. Barrier controller 27 controls operation of motor 23 to effectuate the opening and closing of the barrier 21. In and around the position of the gate will be ultrasonic sensors 29. Ultrasonic sensors 29 will be positioned to detect the presence of any object within the area of the gate. Analysis unit 31 would receive readings obtained by ultrasonic imaging devices 29 and based on this information identify the object located within the operational area of the gate, its position and direction of motion. Based on this information it would provide appropriate instructions to controller 27 so that it will safety and efficiently operate gate or barrier 21.

The system and method of the present invention use ultrasonic or ultrasound transmissions to image the area Z in and around barrier 21. Ultrasonic or ultrasound as is well known in the art, are sound wave transmissions beyond the range of the human hearing. Such sound transmissions are greater than 20,000 Hz. Ultrasound or ultrasonic transmissions offer a number of advantages in that they are not substantially affected by weather, visibility and can be made benign with respect to human contact. Additionally, they offer a very precise measurement tool. A detailed description of ultrasonic or ultrasound transmitters, transceivers or reflective medium is not included herein since these are well known in the art. Because of the high frequency of ultrasonic transmissions they are not only able to provide very precise distance measurements between objects when property positioned they can create images of any objects in their path, the object in the path naturally causing the ultrasonic wave generated by the transmitter to be reflected back towards it. An ultrasonic sensor than picks up these reflected ultrasonic waves. The sensor can be a separate device or part of an ultrasonic transceiver.

By strategically placing two or more ultrasonic transceiver units in and around the gate area a detailed image of any object within the gate operational area can be created. An appropriately programmed analysis unit can then identify the detailed image. The information generated by the analysis unit will include the dimensional shape, mass, direction of movement and speed. With this information an appropriately programmed gate operator can than make a determination as to how the gate should be moved and at what speed of operation.

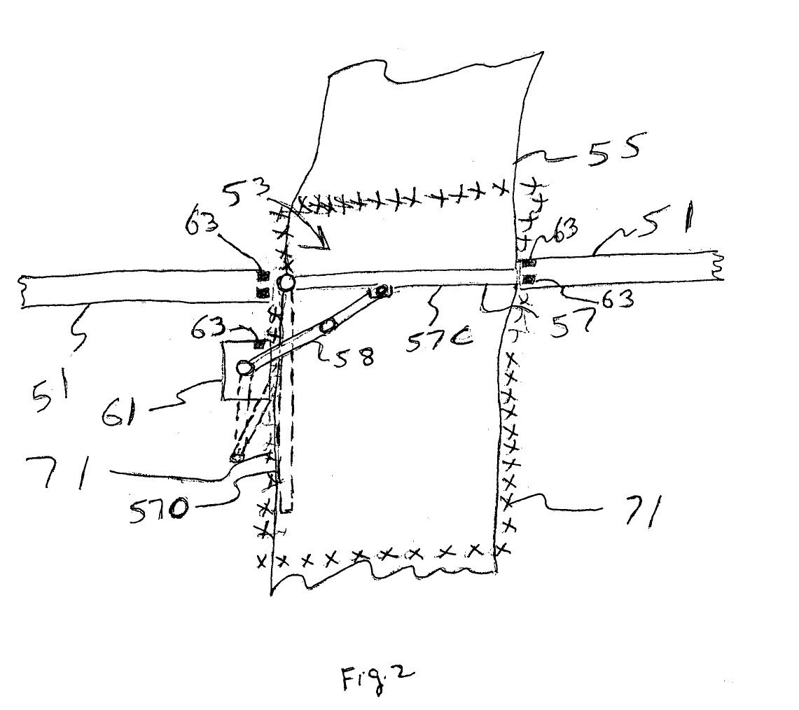

FIG. 2 is a schematic diagram of an overview of an installation of the present invention. Fixed barrier 57 has an opening 53 through access road 55 passes. Movable barrier 57 can be moved between its closed position 57C, in solid lines and its open position 570 by gate motor and movement mechanism contained within unit 61. Only arm 58 of the motor and movement mechanism is shown in FIG. 2. Unit 61 would also house the barrier controller and the analysis unit. Placed around barrier 57 are ultrasonic transceivers 63. Ultrasonic transceivers 63 are connected to the analysis unit housed in 61. Ultrasonic transceivers 63 provide continuous dynamic images of the area in and around barrier 57. The area of coverage is indicated by hatched line 71.

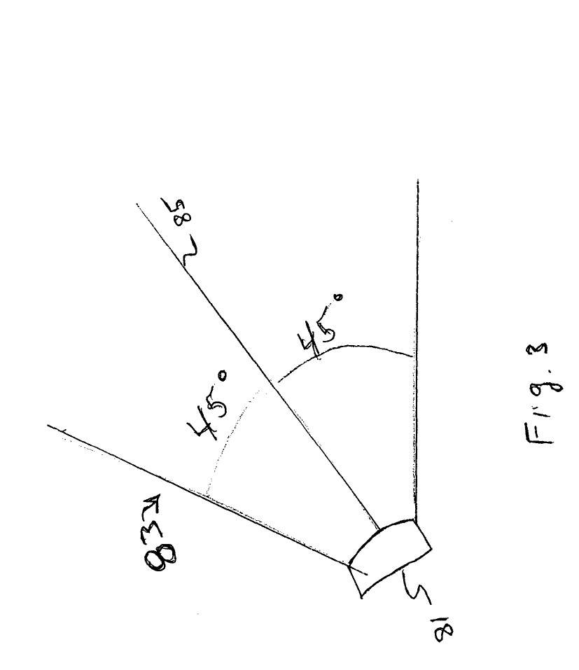

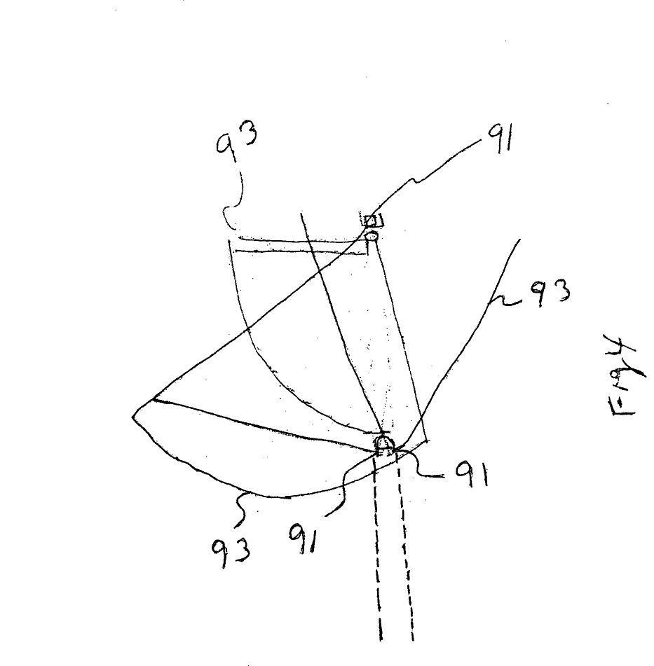

FIG. 3 indicates how one type of ultrasonic sensor transceiver device 81 might work. Transceiver 81 transmits a pattern 83, which would spread out at a 45° angle on the other side of central axis 85 of its transmission line. In the preferred embodiment, the sensor would disregard objects detected beyond a certain range, such as perhaps 14 to 20 feet. This would avoid false detections of objects that would be well out of range of the gate, and the protected area. FIG. 4 depicts how three ultrasonic detectors 91 may be set up on a gate, and the various patterns 93 they would cover with respect to providing coverage in the restricted area.

While the invention has been particularly shown and described with reference to a preferred embodiment thereof, it will be understood by those skilled in the art that various changes in form and detail may be made to it without departing from the spirit and scope of the invention.

We claim:

1. A system for safe operation of a security barrier comprising:
a. a barrier movable between an open and closed position to thereby control access to a security area;
b. a barrier motor to provide power to move said barrier between the open and closed position;
c. a gear mechanism engage able by said barrier motor and operatively connected to transfer power from said motor thereby move said gate between an open and closed position;
d. a barrier controller operatively connected to said motor to control operation of said motor and thereby control opening and closing of said barrier;
e. at least one ultrasonic sensor positioned to monitor areas at and adjacent to said barrier; and
d. an analysis unit to sense objects sensed by said at least one ultrasonic sensor within said areas at and adjacent to said barrier and signal said controller when it is safe to open or close said barrier.

2. The system of claim 1 wherein said at least one ultrasonic sensor is a plurality of ultrasonic sensors.

3. The system of claim 2 wherein said plurality of said ultrasonic sensors are positioned in said areas at and adjacent to said barrier to thereby obtain an ultrasonic image of any object with in said areas.

4. The system of claim 3 wherein said analysis unit uses image information obtained from said plurality of ultrasonic sensors to signal said barrier controller how to operate said barrier.

5. The system of claim 1 wherein said analysis unit would disregard readings from any objects determined to be out of a pre-set distance from the ultrasonic detection units.

6. The system of claim 5 wherein the pre-set distance beyond which readings are disregarded is 20 feet.
